(19) United States
(12) Patent Application Publication
(10) Pub. No.: US 2008/0127830 A1
(43) Pub. Date: Jun. 5, 2008

(54) Air purifier for nail workers

(76) Inventors: Thanh Duc Le, Grand Prairie, TX (US); Kevin Duc Le, Richland Hills, TX (US)

Correspondence Address: Thanh Duc Le, 2831 Andrews Drive, Grand Prairie, TX, 75052, US

(21) Appl. No.: 11/633,102

(22) Filed: Dec. 4, 2006

(51) Int. Cl. B01D 53/02

(52) U.S. Cl. 96/154

(57) ABSTRACT

A compact portable multifunctional tabletop air purifier used to adsorb the chemical fumes that are vaporized from the nail products. The air purifier is comprised of a main housing on a stationary base, a fan, a particle and chemical filter. This tabletop air purifier design provides powerful air inlet suction. Operating on top of the worktable, the air purifier directly extracts the fumes vaporized from nail chemicals including Acetates, Benzaledehyde, Benzyl Alcohol, Acetone, and etc. The main housing of the air purifier can be rotated up to 180 degrees relative to the base to be used as a fan or an artificial fingernail dryer. The present invention will be useful for both nail workers and the clients.

### BACKGROUND OF THE INVENTION

In recent years, there has been increasing attention to the air quality breathed by the nail workers while they are on the job. According to the California Occupational Health Branch (Hazard Evaluation System & Information Service), the chemicals found in artificial nail products can be harmful to human health. These chemicals can enter the body through the air they breathe, through the skin, or through the digestive system when the chemicals are accidentally swallowed. Repeated exposure to these chemicals can cause many health problems that are commonly known and described below.

Respiratory System: The chemicals found in artificial nails can irritate the nose, throat, and lungs. Symptoms include coughing, soreness of the nose and throat, hoarseness, tightness of the chest, shortness of breath, and congestion.

Skin and Eyes: These same chemicals also can irritate human's skin and cause a rash called contact dermatitis. Symptoms of dermatitis include dryness, flaking, and cracking of the skin. When this occurs, the skin is more likely to develop infections. Eye contact with nail product airborne dusts can cause irritation and redness, burning, itching, or discomfort. Vision maybe distorted.

Free Radical Damage: If the chemicals enter the body they may cause failure to internal organs such as liver, lung, and kidney. Most of the substances used in artificial nail products have not been adequately tested for carcinogenic effects. However, some substances occasionally found in artificial nail products have been proven to cause cancers in animal tests.

Presently, there are various air purification systems for this particular application. According to nail workers, these systems are large and installed at the corner of the room. Therefore these systems do not directly suck the fumes away from the worktable. Thus, the nail worker and clients are forced to breathe the contaminated air.

Accordingly, a need remains in the art for compact air purifier to directly purify the air in the selected workspace. It is to the provision of such that the present invention is directed.

### BRIEF SUMMARY OF INVENTION

The present invention overcomes the above disadvantages and meets the need in the art by providing a multifunctional tabletop air purifier that effectively collects the small particles and chemical fumes in the selected application. The present invention will help minimize the health effects of the nail products. The system comprises a housing that has an array of air inlets and outlets to define an airflow path for treating the ambient air, a multilayer activated carbon filter to collect fine particles and adsorb chemical fumes, a fan to create airflow through the housing where particles and chemicals are retained.

The objects, features, and advantages of the present invention will become apparent upon reading of the following description in conjunction with the drawings and the appended claims.

### BRIEF DESCRIPTION OF THE DRAWINGS

FIG. 1 is a perspective appearance of the front view of the air purifier.

FIG. 2 is a perspective appearance of the back view of the air purifier. When the main housing is rotated 180 degrees, the air purifier is operated as a nail drier.

FIG. 3 is a perspective exploded view of the air purifier.

FIG. 4 is a perspective exploded view of the air purifier showing the interface between the main housing and the base. The base and main housing are locked together using a metallic bar.

FIG. 5 is a perspective exploded view of the base showing the features that allow the main housing to rotate and the position locking.

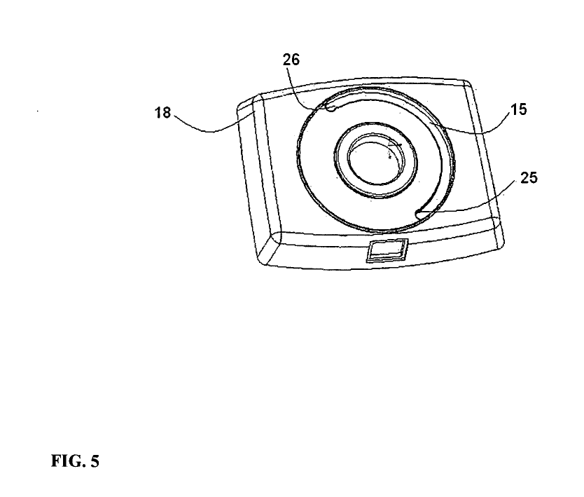

FIG. 6 is a perspective view of the bottom of the main housing back cover, showing the base interfacing feature and rotation position stopper.

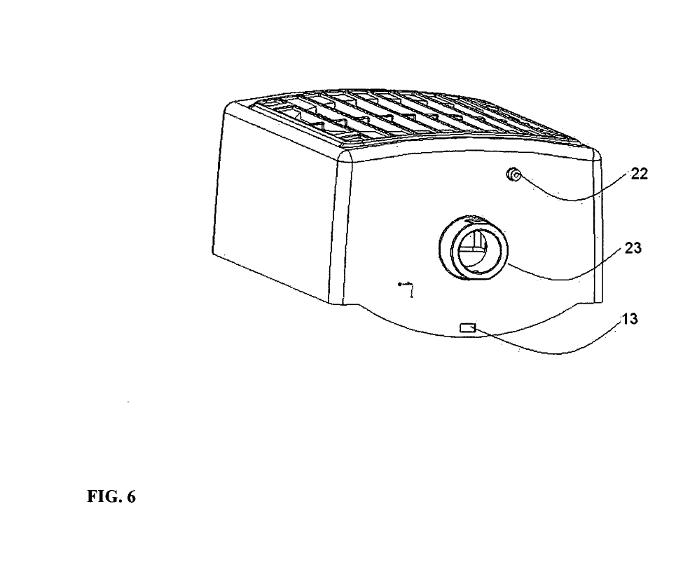

### DETAILED DESCRIPTION OF THE INVENTION

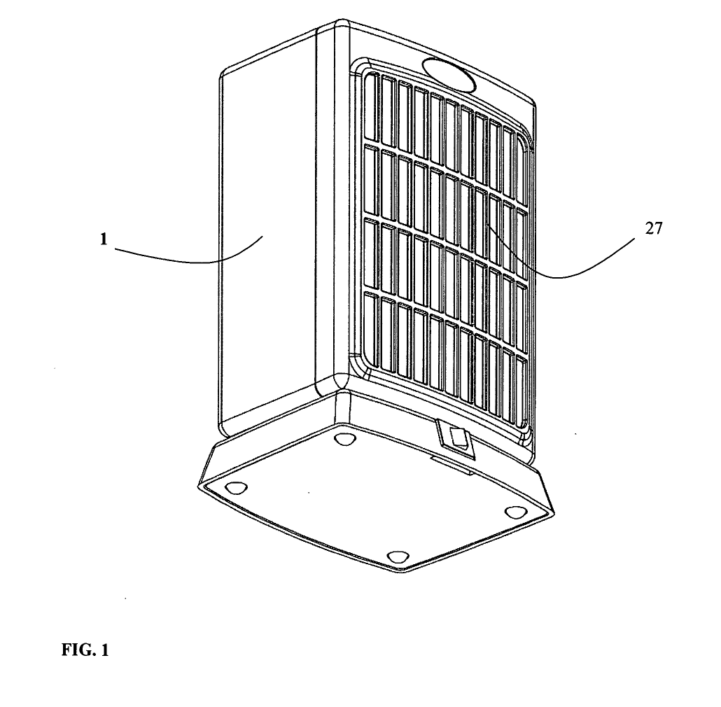

With reference to the drawings, in which like parts have like identifiers, FIG. 1 shows a perspective view of the appearance of the multifunctional air purifier that is specifically used for nail workers. As shown in FIGS. 1, 2 and 3, the air purifier comprises a main housing 1, an array of air inlets 27 formed through the front cover 2 of the main housing 1, and an array of air outlets 28 formed through the back cover 14 of the main housing 1.

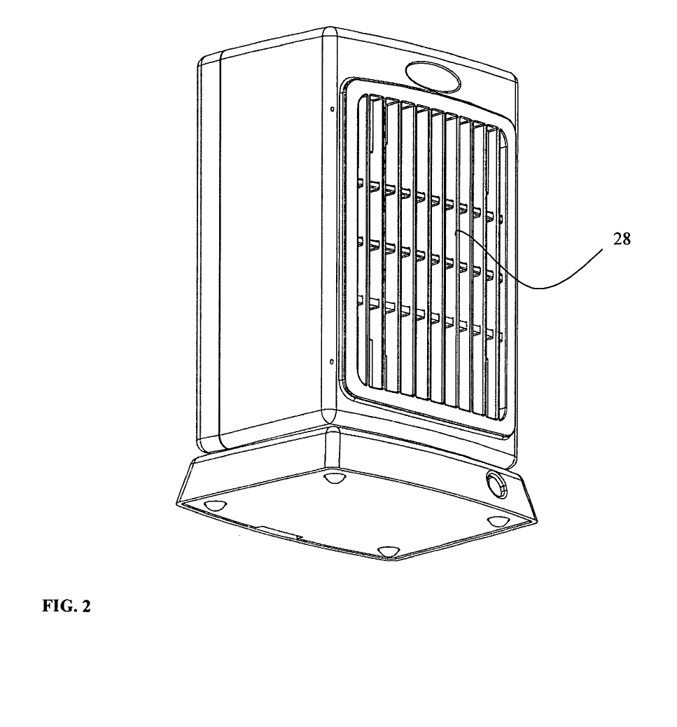

FIG. 2 shows a perspective view of the air purifier as a fan when the main housing 1 is rotated 180 degrees clockwise. When the air purifier is operated in the mode, the outgoing air is cleaned and can be used as a fan or an air drier to dry the artificial fingernails.

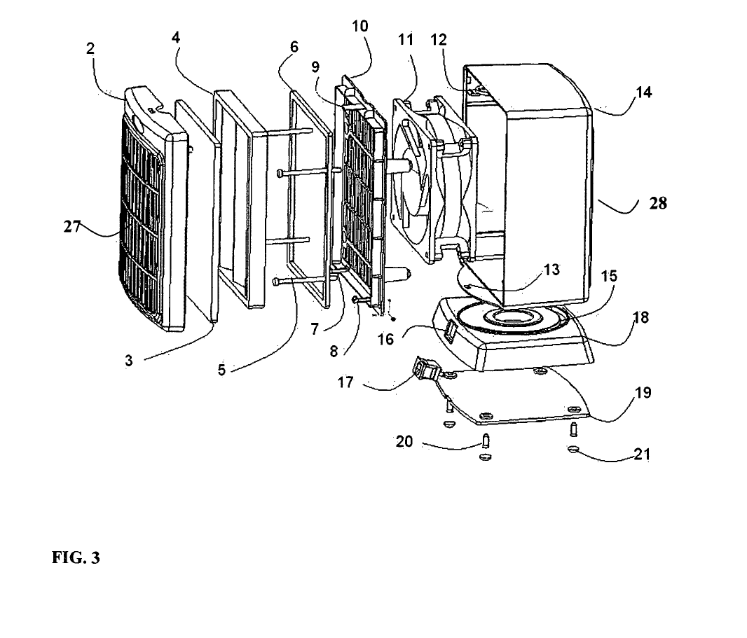

FIG. 3 is a perspective exploded view of the air purifier illustrating in more detail of the present invention. The main housing 1 comprises a multilayer filter 4 for adsorbing the chemical fumes from the nail products, a fan for sucking the air into inlets 27. The air will then pass though the pre-filter 3, multilayer filter 4, then going out from outlets 28.

The pre-filter 3 is placed right in front of the multilayer filter 4 to collect and filter out the large particles before the air enters multilayer filter 4.

The multilayer filter 4 is placed between the pre-filter 3 and the fan 11. The pre-filter 3 is held in the upright position with the support of filter holder 10 and the clamping features 7, 8 and 9. To obtain high airflow rate through the filters, the inner air pressure is maintained with the support of the gasket 6 that is installed on the backside of the filter 4. The filter holder 10 and fan 11 are mounted to the back cover 14 using four of the screws 5.

The multilayer filter 4 includes an activated carbon pad to adsorb the chemical fumes from nail products, and a fiber cloth layer for filtering out the fine particles.

The air purifier main housing 1 comprises a front cover 2 and a back cover 14 snapped together via the support of tap 12 and hole 13 as shown in FIGS. 1 and 3. The front cover 2 can be easily removed from the main housing 1 by pressing tap 12 and then gently pull the front cover 2 forward. This provides users the access to the filters for servicing the machine.

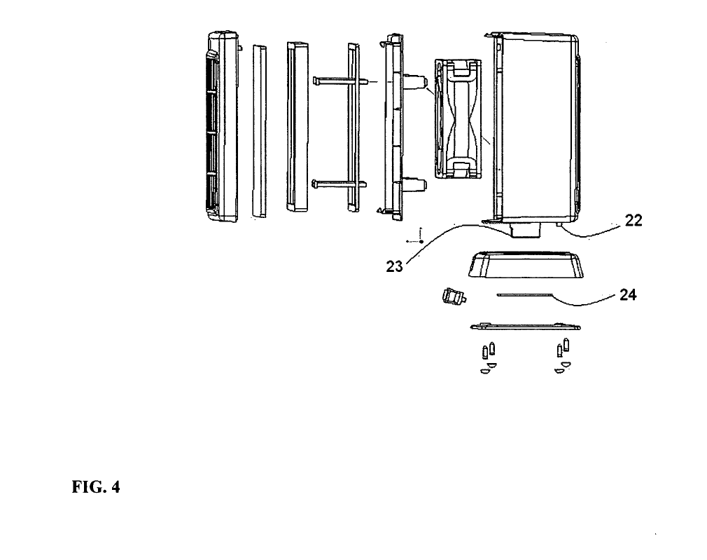

The air purifier main housing 1 is sited on top of a stationary base 18 with the support of pole 23 and locking bar 24 as shown in FIG. 4. The main housing 1 is allowed to rotate only up to 180 degrees to avoid tangling of the wires that provide power to the fan. The stopper 22 defines the maximum rotation angle of the main housing 1. The position of the main housing after rotation is held by small features 25 and 26. Power is connected or disconnected to or from the system with the rocker switch 17. The bottom of the base housing 18 is shielded with a base cover 19 and four screws 20 and four rubber bumpers 21.

What is claimed is:

1. A portable multifunctional air purifier comprising, in combination:
a main housing that has an array of air inlets and outlets to define an airflow path for treating the ambient air
a multilayer filter to collect dust, fine particles and adsorb chemical fumes
a fan to create airflow through the main housing where particles and chemicals are retained in the filters
a stationary base which holds the main housing in the up right position and allows the main housing to rotate

2. The portable multifunctional air purifier according to claim 1 is used for nail workers.

3. The portable multifunctional air purifier according to claim 1 is used on nail tabletop to directly suck in and clean the nail chemical fumes.

4. The portable multifunctional air purifier according to claim 1, comprising at least one multilayer filter.

5. The portable multifunctional air purifier according to claim 4, wherein the filter comprises a pre-filter, an activated carbon pad, and fiber cloth layer.

6. The portable multifunctional air purifier according to claim 5, wherein the activated carbon layer is used to remove the nail chemical fumes.

7. The portable multifunctional air purifier according to claim 1, wherein the main housing can be rotated up to 180 degrees relative to the stationary base.

8. The portable multifunctional air purifier according to claim 7 can be used as a fan or an artificial fingernail dryer.
